(19) United States
(12) Patent Application Publication
(10) Pub. No.: US 2025/0383851 A1
(43) Pub. Date: Dec. 18, 2025

(54) METHODS AND SYSTEMS FOR ITERATIVELY OPTIMIZING EXECUTABLE CODE SOLVING PROGRAMMING PROBLEM USING ARTIFICIAL INTELLIGENCE

(71) Applicant: LastBot Europe Oy, Oulu (FI)

(72) Inventor: Tero Heinonen, Sacramento, CA (US)

(73) Assignee: LastBot Europe Oy, Oulu (FI)

(21) Appl. No.: 19/303,749

(22) Filed: Aug. 19, 2025

Related U.S. Application Data
(63) Continuation-in-part of application No. 18/969,830, filed on Dec. 5, 2024, now Pat. No. 12,412,196.
(60) Provisional application No. 63/606,661, filed on Dec. 6, 2023.

(51) Int. Cl. G06F 8/41; G06F 8/72; G06N 20/00

(52) U.S. Cl. CPC G06F 8/443; G06F 8/72; G06N 20/00

(57) ABSTRACT

Disclosed is a method for iteratively optimizing executable code, the method including: (i) receiving input data set(s) describing code optimization context and performance metric(s) for a programming problem; (ii) generating, by an artificial intelligence (AI) model, candidate code instance(s) as proposed solutions to the problem, the generation being conditioned on structured semantic representation of the context and performance metric(s); (iii) evaluating, for each candidate code instance, a performance score using a machine learning evaluation model, the performance score indicating performance characteristic of candidate code instance(s) with respect to performance metric(s); (iv) adjusting parameters or input conditions of AI model for subsequent iteration of candidate code generation, based on evaluation feedback; (v) repeating steps (ii), (iii), and (iv) iteratively to progressively improve performance characteristic of candidate code instance(s) until termination condition is satisfied; and (vi) selecting, upon the satisfaction, candidate code instance(s) as optimized executable code solution, and outputting the selection.

### CROSS-REFERENCE TO RELATED APPLICATIONS

This application is a continuation-in-part of U.S. patent application Ser. No. 18/969,830, titled “A METHOD AND SYSTEM FOR USING AI MODELS TO OPTIMIZE A GOAL” and filed on 2024 Dec. 5, which claims priority from U.S. Provisional Patent Application Ser. No. 63/606,661 filed on 2023 Dec. 6, the disclosures of which are incorporated herein by reference in their entireties.

### TECHNICAL FIELD

The present disclosure relates to computer-implemented methods for iteratively optimizing executable code solving a programming problem using artificial intelligence (AI). The present disclosure also relates to systems for iteratively optimizing executable code solving a programming problem using AI.

### BACKGROUND

The execution performance of software code (or ‘code’) plays a critical role in a wide range of computational tasks. In most cases, the execution performance of the code is evaluated prior to code deployment, for example to ensure acceptable runtime latency, resource usage, scalability, or similar. In many cases, the code is further optimized after such evaluation, to improve its execution performance in a target execution environment.

Evaluating the performance of the code typically involves compiling and executing the code in a representative setting. This process is often time-consuming and computationally expensive, particularly in complex domains such as machine learning, data-intensive processing, or high-performance computing. For example, a deep learning model may involve multiple hyperparameters such as a depth of a neural network, a width of token embeddings, a number of parallel heads per layer, a type of positional encoding used, an activation function, a dropout rate, a learning rate, an optimizer, a batch size, or similar. Evaluating the performance of the deep learning model would involve training said model with various hyperparameter combinations, and then obtaining a result performance of each hyperparameter combination. This training and evaluation may require a lot of time (sometimes spanning days or weeks) and may also require significant computing infrastructure. As a result of such constraints, only a limited number of configurations can be realistically evaluated.

Furthermore, optimization of the code relies on conventional compiler heuristics or human-guided fine-tuning. These optimization methods are typically error-prone, inflexible, and are difficult to scale. Nowadays, some modern tools utilize artificial intelligence to assist with code optimization, but these tools still depend heavily on execution-based feedback or operate within limited domains. As a result, code optimization process still remains suboptimal, inefficient, and resource-intensive.

Therefore, in light of the foregoing discussion, there exists a need to overcome the aforementioned drawbacks.

### SUMMARY

The present disclosure seeks to provide a method and a system for iteratively optimizing executable code solving a programming problem using artificial intelligence (AI). The aim of the present disclosure is achieved by a system and a method which incorporate performance-guided iterative code generation and evaluation using artificial intelligence and machine learning models, as defined in the appended independent claims to which reference is made to. Advantageous features are set out in the appended dependent claims.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1 is a flowchart illustrating steps of a computer-implemented method for iteratively optimizing executable code solving a programming problem using artificial intelligence (AI), in accordance with an embodiment of the present disclosure;

FIG. 2 is a block diagram of a system for iteratively optimizing executable code solving a programming problem using artificial intelligence (AI), in accordance with an embodiment of the present disclosure;

FIG. 3 is an exemplary graphical representation illustrating iterative optimization of executable code, in accordance with an embodiment of the present disclosure; and

FIG. 4 is an exemplary graphical representation illustrating convergence towards an optimized executable code solution to a programming problem, by iterative optimization of executable code, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In a first aspect, an embodiment of the present disclosure provides a computer-implemented method for iteratively optimizing executable code solving a programming problem using artificial intelligence (AI), the method comprising executing machine-readable instructions stored on a non-transitory computer-readable memory by at least one processor for:
(i) receiving one or more input data sets describing a code optimization context and at least one performance metric for the programming problem;
(ii) generating, by an AI model, one or more candidate code instances as proposed solutions to the programming problem, wherein the generation is conditioned on a structured semantic representation of the code optimization context and on the at least one performance metric;
(iii) evaluating, for each candidate code instance, a performance score using a machine learning evaluation model distinct from the AI model, the performance score indicating a performance characteristic of the one or more candidate code instances with respect to the at least one performance metric;
(iv) adjusting one or more parameters or input conditions of the AI model for a subsequent iteration of candidate code generation, based on feedback from the evaluation;
(v) repeating steps (ii), (iii), and (iv) iteratively to progressively improve the performance characteristic of the one or more candidate code instances with respect to the performance metric until a termination condition is satisfied; and
(vi) selecting, upon satisfaction of a termination condition, at least one candidate code instance as an optimized executable code solution to the programming problem, and outputting the selected at least one candidate code instance.

The present disclosure provides the aforementioned computer-implemented method. The method provides a systematic, AI-driven optimization process for iterative code optimization. By generating the one or more candidate code instances through the first AI model, adaptive intelligence is leveraged effectively for code generation. This provides time and computational resource efficiency over manual or static heuristics that are typically associated with code generation. The use of the machine learning evaluation model to evaluate each candidate code instance enables a rapid and predictive assessment of code performance. This leads to substantial improvements in evaluation speed, particularly in environments where running the code is computationally expensive or time-consuming, in contrast to conventional approaches which rely on full code execution for code performance evaluation. Furthermore, integration of a feedback loop that refines the one or more parameters or input conditions of the first AI model, based on the feedback from previous evaluations allows optimization to progressively converge towards the optimized executable code solution that is high-performing, in a controlled and data-driven manner. This feedback loop enables the subsequent iteration of candidate code generation to occur in a few milliseconds, as opposed to several hours, days, or weeks required using conventional solutions. The method provides a scalable and deployable framework for accelerating code optimization, for enhancing execution efficiency, and reducing code development time and cost.

Together, the integration of adaptive code generation, predictive performance evaluation, and iterative feedback refinement yields a synergistic effect of enabling rapid, resource-efficient convergence towards the optimized executable code solution without requiring full code execution of any candidate code in any iteration. This synergistic effect arises from the interaction of the first AI model and the machine learning evaluation model within a closed-loop feedback architecture, wherein each model continuously informs and improves the other. This closed-loop feedback architecture enhances functioning of computer systems (comprising the at least one processor) by enabling faster convergence toward optimal solutions, reducing processor cycles spent on unnecessary code compilations, and improving system throughput and resource utilization across diverse workloads and hardware configurations.

The “executable code” refers to a code instance comprising software instructions that are capable of being compiled and/or interpreted for execution, to solve the programming problem within a target execution environment. The executable code may be expressed in various representations, including but not limited to high-level source code, intermediate representations, byte-code, or low-level machine instructions. Regardless of representation, the executable code is structurally and semantically complete, so it can be evaluated for execution behaviour and performance according to the at least one performance metric. The executable code may implement a full program or a partial component (such as a function, a kernel, or a computational module).

The “programming problem” refers to a defined computational task or objective for which the executable code is to be generated and optimized.

The programming problem may, for example, involve implementing an algorithm, performing a transformation, processing input data, producing an output under specific functional and/or performance constraints, or similar. The programming problem may be described in natural language, formal specifications, code snippets, pseudocode, or similar. The programming problem may also optionally include environmental context such as available hardware resources, memory limitations, concurrency models, execution platform characteristics, or similar. The programming problem serves as a foundation for generating the one or more candidate code instances and for defining the at least one performance metrics used during evaluation. Throughout an optimization process involving use of AI and machine learning techniques, the programming problem remains fixed, while the one or more candidate solutions are iteratively improved to better address the programming problem in terms of correctness, performance, or resource utilization. Leveraging such an optimization process enables dynamic improvement of the one or more candidate solutions over multiple iterations, to finally yield the at least one candidate code instance as the optimized executable code solution to the programming problem. The optimization process is encompassed in the computer-implemented method described herein. The computer-implemented method may be referred to as ‘method’ in the present disclosure, for sake of simplicity only. The method is implemented on a computing device (i.e., a computer) comprising the at least one processor, wherein the non-transitory computer-readable memory is communicably coupled to the at least one processor.

The “non-transitory computer-readable memory” refers to any physical, tangible storage medium that can store the machine-readable instructions for later retrieval and execution by the at least one processor. This memory is a persistent storage medium. Examples of said memory include, but are not limited to, magnetic storage devices (such as hard disk drives), optical storage media (such as CDs or DVDs), flash memory devices (such as SSDs, USB drives), and semiconductor memories (such as DRAM, SRAM, or ROM).

The one or more input data sets comprise at least one of: structured data, unstructured data, describing the code optimization context and the at least one performance metric for the programming problem. Receiving the one or more input data sets is important as data comprised therein defines a basis for optimization and evaluation of the executable code. Optionally, the one or more input data sets are received from at least one data source. The at least one data source may, for example, comprise at least one of: a local storage device, a remote server, a database, a code repository, a performance-monitoring system, or a network-based data feed. The local storage device may, for example, be the non-transitory computer-readable memory.

The code optimization context describes scope and boundaries of the optimization process. Optionally, the code optimization context comprises at least one of: a definition of the programming problem, information pertaining to the target execution environment, compiler or runtime constraints, characteristics of workload, existing baseline implementation. The code optimization context can be in various forms, for example, such as a structured file, an intermediate-representation code, an abstract syntax tree, or similar.

The at least one performance metric is one or more quantitative measures against which each candidate code instance is to be evaluated. In other words, performance metrics are categories or aspects for performance evaluation of each candidate code instance. Optionally, the at least one performance metric comprises at least one of: an execution time or latency-related metric, a throughput metric, a memory efficiency metric, an energy consumption metric, an accuracy-related metric. It will be appreciated that each performance metric can have one or more performance characteristics (described later) that are indicative of said performance metric. The at least one performance metric could be a single metric, multiple single metrics, a composite metric, a weighted metric, or similar.

The AI model is a generative AI model (for example, such as a code-capable Large Language Model (LLM), a code-generation transformer-based neural network, or similar). The AI model generates the one or more candidate code instances such that each candidate code instance is complete and evaluable on its own. The AI model takes the one or more input datasets as its input, and generates the one or more candidate code instances as its output. Additionally, the AI model also takes the feedback from the evaluation as its input, for subsequent iterations of candidate code generation. In some implementations, the AI model is a single AI model, whereas in other implementations, the AI model is a combined AI model comprising a plurality of AI models.

The structured semantic representation of the code optimization context is a machine-readable format which describes semantics of the optimization process. These semantics relate, for example, to execution situation (such as hardware and/or software) in which the executable code is to run, and rules or conditions that the executable code must follow. The structured semantic representation is easily readable and usable by the AI model.

Conditioning the generation of the one or more candidate code instances on the structured semantic representation of the code optimization context and on the at least one performance metric ensures that the one or more candidate code instances are tailored to the programming problem and adapted to optimization objectives and process. Furthermore, said conditioning beneficially reduces a likelihood of generating incompatible or invalid candidate code instances. This improves an initial quality of candidate code instances, which increases efficiency of subsequent evaluation and feedback steps in the optimization process. By aligning generated candidate code instances with performance metric(s) from the outset, this approach increases a probability that early-stage candidate code instances will achieve higher scores during evaluation, thereby accelerating convergence toward the optimized executable code. The technical effect is a reduction in wasted computation cycles on unsuitable candidates, improved utilization of processing and memory resources during the optimization process, and faster attainment of candidate code instances that satisfy both functional correctness and performance objectives. This leads to an overall improvement in system throughput and responsiveness, when performing iterative code optimization.

Next, the machine learning evaluation model (hereinafter referred to as ML evaluation model, for sake of simplicity only) evaluates performance of the one or more candidate code instances, without actually executing any candidate code instance. For evaluating the performance of any candidate code instance, the ML evaluation model estimates the performance score of the performance characteristic of said candidate code instance with respect to the at least one performance metric. The ML evaluation model may be implemented as at least one of: a neural network, a multilayer perceptron (MLP), a decision tree, a random forest, a gradient boosting machine, a regression model, a gradient-boosted regression model. Optionally, the ML evaluation model evaluates the performance of the one or more candidate code instances, based also on at least one of: historical evaluation data, historical execution data, of previous candidate code instances that are similar to the one or more candidate code instances.

The ML evaluation model is separate from the AI model, which beneficially ensures that performance evaluation is free from overfitting to generation-bias. This distinction (i.e., separation) between these models allows each model to be optimized for its own specialized task.

The performance characteristic of a candidate code instance is a measurable property that indicates how the candidate code instance is expected to perform, for one or more specific aspects of code performance defined by the at least one performance metric. Furthermore, the performance characteristic may comprise one or more characteristics related to code performance. As discussed previously, one or more performance characteristics can be indicative of any performance metric. As an example, when the at least one performance metric comprises the execution time or latency-related metric, the performance characteristic may be wall-clock time, microseconds per operation, CPU cycles per instruction, tail latency, cold-start latency, or similar. As another example, when the at least one performance metric comprises the throughput metric, the performance characteristic may be number of processed items or samples per second, frames per second, transactions per second, requests per second, or similar. As yet another example, when the at least one performance metric comprises the memory efficiency metric, the performance characteristic may be peak RAM usage, cache hit rate, memory bandwidth utilization, working set size, shared memory usage efficiency, or similar. As still another example, when the at least one performance metric comprises the energy consumption metric, the performance characteristic may be joules per computation, average power draw, energy-delay product, performance per watt, or similar. As yet another example, when the at least one performance metric comprises the accuracy-related metric, the performance characteristic may be mean squared error, inference accuracy, peak signal-to-noise ratio, bit error rate, or similar.

The performance score of a candidate code instance is a quantitative value representing how well the candidate code instance aligns with the at least one performance metric. In other words, the performance score is a numerical value, produced by the ML evaluation model for the candidate code instance, indicating the candidate code instance's performance characteristic with respect to the at least one performance metric. Optionally, in the ML evaluation model, the performance score is computed by applying a scoring function to the performance characteristic such that a closer alignment of the performance characteristic with the at least one performance metric yields a higher performance score. This could mean that when the at least one performance metric is a metric that is to be minimized by optimization, such as the execution time or latency-related metric, the scoring function transforms the performance characteristic, for example, the wall-clock time, such that a lower value of the performance characteristic results in a higher performance score.

It will be appreciated that evaluation of the performance score for each candidate code instance allows direct comparison and accurate ranking of multiple candidate code instances, for use in the described iterative optimization process. As this evaluation is performed without actually executing any candidate code instance, it eliminates substantial time, computational resources, and energy consumption that would otherwise be required to compile and run each instance. By avoiding full execution, the predictive evaluation capability both accelerates convergence toward high-performing solutions and reduces the computational burden on hardware resources, thereby improving overall throughput and responsiveness of the optimization process.

The feedback from the evaluation of each candidate code instance comprises at least one of: the performance score, a value of the performance characteristic, of said candidate code instance. This feedback is sent from the ML evaluation model to the AI model. This feedback serves as a quantitative signal for guiding the subsequent iteration of candidate code generation. The feedback is used for adjusting the one or more parameters or the input conditions of the AI model. This step of adjusting may involve a reinforcement learning technique, an evolutionary optimization algorithm, a meta-learning strategy, or similar. A technical effect of dynamically adjusting code generation strategy (without altering the programming problem), based on the feedback, is that the AI model's subsequent outputs are progressively biased toward more promising solution regions in a search space of the optimization process. This targeted exploration increases the efficiency of the iterative optimization loop, shortens convergence time to high-performing candidate code instances, and enhances resource utilization by focusing computation on candidate code instances with highest predicted likelihoods of meeting or exceeding the at least one performance metrics.

The one or more parameters of the AI model can be understood to be operational settings of the AI model, which influence how the AI model produces the one or more candidate code instances. Examples of the one or more parameters may include, but are not limited to, code generation hyperparameters, internal weights, bias vectors, penalty terms or reward shaping factors, optimization settings, and model architectural settings.

The one or more input conditions of the AI model can be understood to be external contextual or conditioning inputs provided to the AI model, prior to or during generation of the one or more candidate code instances. Such input conditions influence content, structure, and constraints of the generated candidate code instances. Examples of the one or more input conditions may include, but are not limited to, the structured semantic representation of the code optimization context, weighting of the at least one performance metric, constraints of the target execution environment, inclusion or exclusion lists specifying code patterns, instruction sequences, or libraries to use or avoid, and baseline code examples, templates, or partial implementations derived from results of earlier iterations in the optimization process.

The steps (ii), (iii), and (iv) of the method are repeated in a cyclic manner over multiple iterations, until the termination condition is satisfied. During each iteration, the adjustments made in the step (iv) alter generative behaviour of the AI model so that subsequent candidate code instances differ from prior ones in ways expected to improve alignment with the at least one performance metric. The iterative repetition ensures that the feedback from the step (iii) is not applied in isolation, but rather is incorporated into a continuous refinement cycle in which the solution space is explored thoroughly and exploited in a balanced manner. In this way, the optimization of the at least one candidate code instances occurs while preserving knowledge gained from previous iterations. This process increases a likelihood of finding globally optimal or near-optimal candidate code instances rather than local optima and allows dynamic balanced exploration of new optimization strategies with exploitation of known effective ones. As a result, the optimization process achieves a higher-quality final solution, which is the form of the at least one candidate code instance, within practical resource and time constraints.

After each iteration of the steps (ii), (iii), and (iv), the method further comprises checking whether the termination condition is satisfied. When it is determined that the termination condition is satisfied, the step (vi) of the method is implemented. Otherwise, when it is determined that the termination condition is not satisfied, a next iteration of the steps (ii), (iii), and (iv) is initiated as the step (v) of the method.

The termination condition is a predefined stopping criterion for repeated iterative optimization of the one or more candidate code instances. The termination condition may be based on one or more criteria. Examples of the one or more criteria include, but are not limited to, the at least one candidate code instance achieving a performance score that meets or exceeds a target performance threshold for the at least one performance metric, the step (v) reaching a maximum allowable number of iterations, exceeding a time budget allocated for optimization, exhaustion of computational resources available for the process, detection of convergence such that further iterations produce negligible improvement in the performance score.

Upon satisfaction of the termination condition, the at least one candidate code instance is selected, from amongst the one or more candidate code instances generated during the repetitive iterative optimization, as the optimized executable code solution to the programming problem. The at least one candidate code instance could be a single candidate code instance or a plurality of candidate code instances. Optionally, the selection of the at least one candidate code instance is based on one or more criteria which specifies that a candidate code instance is selected when:
its performance score lies within N highest performance scores achieved during the optimization process,
it meets or exceeds the target performance threshold of the performance score for the at least one performance metric, or
it is determined to meet an additional constraint, compatibility requirement, or energy efficiency target.

The optimized executable code solution comprises the selected at least one candidate code instance. This means that any of the selected at least one candidate code instance can be utilized as the optimized executable code. By the step of outputting, the selected at least one candidate code instance is made available for use outside of the optimization process (i.e., the method). A form in which the selected at least one candidate code instance is outputted may depend on intended integration or deployment plans. The selected at least one candidate code instance may be outputted by one or more of: displaying on a user interface of a user device, storing in the non-transitory computer-readable memory, transmitting to another computing system over a communication interface, integrating into a downstream software build or deployment pipeline, or similar.

As an example, the programming problem may be ‘sorting a list of integers in ascending order’.

The code optimization context may comprise:
a definition of this programming problem;
the target execution environment: a laptop CPU with 4 cores, 2.5 GHZ, 8 MB cache;
programming language: Python;
constraint: memory usage should remain under 100 MB;
workload characteristic: integer values range from −1000 to +1000; and
   baseline implementation: Python's built-in sort( ) function.

In this case, the at least one performance metric could be execution time in milliseconds and peak RAM usage.

The AI model may generate multiple candidate code instances, such as parallelized merge sort, an in-place quicksort optimized for small integer ranges, and a counting sort leveraging NumPy.

The ML evaluation model may evaluate, without code execution, performance scores for each of these candidate code instances. The performance scores indicate predicted execution latency of these candidate code instances with respect to the execution time in milliseconds and the peak RAM usage. These performance scores may be shared as feedback to the AI model.

The AI model may use this feedback to iteratively adjust its parameters or input conditions, so that subsequent candidate code instances are biased toward approaches that are predicted to yield lower execution latency while satisfying the memory constraint. The termination condition for stopping such iterations may be that a candidate code instance ‘achieves a target predicted execution latency. As an example, a highest-scoring candidate code instance (such as a variant of the counting sort leveraging NumPy) may be then selected as the optimized executable code for the sorting problem.

Optionally, the optimized executable code solution also comprises metadata associated with the selected at least one candidate code instance. This metadata could include, for example, one or more of:
the performance score(s) achieved by the selected at least one candidate code instance,
the one or more parameters or input conditions of the AI model which produced the selected at least one candidate code instance,
a number of iterations (of steps (ii), (iii), and (iv)) performed;
the information pertaining to the target execution environment.

By also outputting the metadata, it is ensured that results of the optimization process are both usable and contextually traceable. This allows immediate deployment of the optimized executable code in the target environment without additional optimization passes, accelerates integration into production systems, and enables reproducibility of the optimization process for future updates or auditing.

Optionally, the code optimization context comprises a sequence of machine-level or intermediate-representation instructions, and the iterative generation and evaluation steps optimize ordering of those instructions to minimize pipeline stalls or branch mis-predictions while preserving functional equivalence of the one or more candidate code instances. In this regard, the optimization process is specifically applied to at least the sequence of machine-level or intermediate-representation instructions (hereinafter referred to as ‘instruction sequence’ for simplicity only). The instruction sequence provides a low-level baseline framework for generating and optimizing the one or more candidate code instances in a way that preserves their functional equivalence. This means that an overall computational result, effects, observable behavior, and similar, of the one or more candidate code instances remains identical or similar to the instruction sequence.

Including the instruction sequence in the code optimization context focuses the iterative generation and evaluation steps for generating candidate code instances having multiple alternative orderings of the instructions present in the instruction sequence and/or in a candidate code instance generated during a previous iteration. These alternative orderings are derived by respecting data dependencies and control flow defined in the instruction sequence. This optimization approach leverages the fact that the ordering of the instructions can have a significant impact on performance characteristics, such as pipeline stalls or branch mis-predictions, due to characteristics of processors and execution pipelines.

In any iteration, when performance scores indicating pipeline stalls or branch mis-predictions are predictively evaluated for different candidate code instances with different orderings, the AI model subsequently adjusts its parameters or input conditions to produce subsequent reorderings that are likely to reduce pipeline stalls or branch mis-predictions (and thus improve the performance scores).

In this way, the method systematically explores and exploits instruction orderings that are better suited (than the instruction sequence) to the target execution environment, without executing code, enabling rapid iteration and code optimization. The resulting candidate code instances retain functional correctness of the instruction sequence but achieve lower execution latency, reduced pipeline stalls, and improved processing resource utilization.

Optionally, the one or more candidate code instances encode alternative memory-layout configurations for data structures, and the machine learning evaluation model computes performance scores that reflect reductions in cache-miss rates, avoidance of memory-bank conflicts, or improved locality across multiple cache levels. Optionally, in this regard, the code optimization context also comprises information describing structure, allocation, and organization of data in memory. The one or more candidate code instances generated by the AI model vary in how the data structures are laid out in the target execution environment's memory hierarchy. Across different memory-layout configurations in these candidate code instances, a logical interpretation of the data remains unchanged, but how the data is arranged physically in memory is different. In other words, the alternative memory-layout configurations are semantically equivalent.

The ML evaluation model predicts an impact of each memory-layout configuration on the performance characteristic, without executing candidate code instances, and determines a corresponding performance score for each memory-layout configuration. The AI model then adjusts its parameters or input conditions to produce subsequent candidate code instances with memory-layout configurations that further optimize the performance characteristic in line with the at least one performance metric.

This approach enables rapid exploration of a large design space of memory-layout configurations, such that resulting candidate code instances can achieve improved cache utilization, reduced memory-access latency, and fewer memory-bank conflicts. This leads to higher effective throughput for memory-bound workloads, better scaling in parallel execution environments, and more efficient use of available hardware memory resources.

Optionally, each candidate code instance specifies a unit of parallelism for executing a workload, and the machine learning evaluation model predicts execution-time or throughput improvements arising from a granularity indicated by the unit of parallelism. Optionally, in this regard, the code optimization context further comprises at least one of: information about parallel execution capabilities of the target execution environment, workload-specific properties. The information about the parallel execution capabilities of the target execution environment may, for example, comprise at least one of: a number of available cores, SIMD width, GPU warp size, network topology in a distributed computing system, or similar. The workload-specific properties may, for example, comprise at least one of: data-dependency graphs, synchronization points, memory-sharing patterns, or similar.

The unit of parallelism defines how the workload (associated with the programming problem) is divided into tasks or threads and distributed for execution across the available processing elements in the target execution environment. Examples of the unit of parallelism include, but are not limited to, number of threads per block in a GPU kernel, number of iterations per thread in a CPU vectorized loop, degree of partitioning in a distributed computing task, and batch size for concurrent data processing tasks.

The AI model generates the one or more candidate code instances that differ in their specified unit of parallelism. These differences are designed to preserve functional correctness but may significantly affect execution performance. The ML evaluation model beneficially predicts, without code execution, how each unit of parallelism will influence the performance characteristic of each candidate code instance. The performance characteristic may, for example, comprise one or more of execution time, latency, throughput, resource utilization efficiency for CPU, GPU, or TPU cores, synchronization overhead, occupancy metrics for GPUs or other accelerators, or similar. The feedback from the ML evaluation model to the AI model may be in the form of performance scores assigned to each candidate code instance for its specified unit of parallelism. The AI model then uses this feedback to adjust its parameters or input conditions so that subsequent candidate code instances are generated with units of parallelism which are more likely to yield higher performance scores.

By systematically exploring multiple parallelism granularities without executing any candidate code instance, this approach allows the optimization process to converge on a balance between workload concurrency and execution efficiency. The result is the at least one candidate code instance that, relative to other candidate code instances generated previously during the iterative process, achieves higher total throughput, reduces idle time for processing units, minimizes synchronization penalties, and scales more effectively across available hardware resources.

Optionally, the iterative generation produces candidate sets of function-inlining directives, and the machine learning evaluation model scores each candidate set according to a weighted objective that balances call-overhead reduction against instruction-cache pressure. Optionally, in this regard, the code optimisation context further comprises at least one of: information about call overhead characteristics, the target execution environment's instruction-cache capacity and organisation, workload-specific information.

Herein, the term “candidate set” refers to one or more candidate code instances generated within a single iteration of the optimisation process. Each candidate code instance in the candidate set includes a complete set of function-inlining directives applicable to its relevant call sites or functions, thereby defining one self-contained inlining strategy for that instance. Furthermore, the term “function-inlining directives” refers to instructions or flags controlling whether and how individual functions are inlined. Examples of function-inlining directives include, but are not limited to, per-function attributes (e.g., always_inline, noinline), per-call-site decisions, inlining thresholds, per-module inlining budgets, and comments or hints that govern inlining eligibility.

The scoring by the ML evaluation model is performed without executing any candidate code instance. The performance score is a measure of how well a candidate code instance's function-inline directives meet the weighted objective or progressively converge towards the weighted objective. The “weighted objective” is a quantifiable function that represents a trade-off balance between call overhead reduction and instruction-cache pressure, which are competing effects of inlining.

In this regard, the performance score indicates the performance characteristic comprising one or more of call/return overhead cycles saved, instruction-cache miss rate at one or more cache levels, instruction working-set size, predicted execution latency on frequently-executed paths, code-size growth ratio, or similar. The performance score for a candidate set may depend on individual performance scores for each candidate code instance amongst that candidate set. The performance score for each candidate set, or each individual candidate code instance of each candidate set, may be sent as the feedback to the AI model. The AI model uses this feedback to adjust its parameters or input conditions (for example, such as inlining-threshold proposals, inclusion/exclusion heuristics for specific call sites, or similar), so that subsequent candidate sets are biased toward achieving higher performance scores.

By iteratively generating and scoring the candidate sets with the weighted objective, the method rapidly converges toward the at least one candidate code instance that, relative to other candidate sets generated previously during the iterative process, attains lower effective call overhead while avoiding excessive instruction-cache pressure. This reduces execution latency on frequently-executed paths and improves alignment with the at least one performance metric.

Optionally, each candidate code instance represents a just-in-time compilation strategy and the machine learning evaluation model selects a strategy that is projected to yield a highest runtime performance for current workload characteristics. The “just-in-time (JIT) compilation strategy” refers to a plan for compiling and optimizing a code right before it runs, based on a current workload. The JIT compilation strategy may comprise one or more of directives, parameters, or heuristics that control code generation, scheduling, optimisation passes, register allocation, and machine-level instruction selection performed immediately prior to execution. In this regard, the code optimisation context optionally further comprises information describing current workload characteristics. Said information comprises, for example, one or more of present input data patterns, dataset size, processing resource load, current execution environment configuration, or similar.

With respect to the above embodiment, the ML evaluation model predicts, without executing any candidate code instance, how each JIT compilation strategy will affect the performance characteristic indicative of the at least one performance metric, given the current workload characteristics. The performance characteristic may, for example, include one or more of predicted execution time, throughput, compilation latency, memory usage, energy consumption, or hardware resource utilisation efficiency. The performance score reflects a projected runtime performance impact of each JIT compilation strategy under the current workload characteristics, and may be sent as the feedback to the AI model. The AI model uses this feedback to adjust its parameters or input conditions so that subsequently-generated candidate code instances are biased toward JIT compilation strategies that are more likely to yield higher performance scores under similar workload conditions.

A technical effect of the above embodiment is that the method converges toward the at least one candidate code instance produced using a JIT compilation strategy that delivers improved runtime performance, reduced execution latency, and better alignment with the at least one performance metric for the current workload. This adaptive approach tailors compilation decisions to the actual workload and system state, enabling optimizations that maximise hardware utilisation, minimise wasted computation, and enhance responsiveness under dynamic conditions.

Optionally, the method further comprises generating multiple semantically equivalent variants of a function or a kernel, executing each variant to verify semantic equivalence, and evaluating the variants for performance or resource-utilization improvements before selecting at least one variant as an optimized implementation. The phrase “multiple semantically equivalent variants” refers to a plurality of candidate code instances which produce exactly the same results when executed, even if their code is different. The AI model may be configured to perform said generation. In this embodiment, the ML evaluation model may execute (i.e., run) each variant, and upon verification of the semantic equivalence, may measure and compare performance or resource-utilization of the variants. The performance or resource-utilization may be measured and compared using the performance characteristic with respect to the at least one performance metric. The at least one variant that is selected as the optimized implementation is that which runs faster and/or uses fewer resources than other variants. A technical effect of this execution-augmented optimization is that performance and/or resource-utilization improvements can be realized without altering functional behavior of candidate code instances. This approach eliminates a risk of introducing functional errors during performance tuning, accelerates convergence toward most efficient variant(s), and improves alignment with the at least one performance metric.

Optionally, the AI model generates the one or more candidate code instances that leverage documented or undocumented side-effects of target execution environments to reduce instruction count, and the machine learning evaluation model validates functional correctness of the one or more candidate code instances while measuring performance gains attributable to the side-effects. In this regard, the documented side-effects may be obtained from official manuals, specifications, web-forums, support resources, or similar. The undocumented side-effects are not officially stated, but observed in practice. Notably, when the one or more candidate code instances are generated to deliberately exploit said side-effects in the target execution environments, for achieving the same results with fewer instructions, it improves code efficiency. The ML evaluation model performs the validation, without code execution, to ensure that the candidate code instances generate expected results, despite using the side-effects. This validation may be done using reference-oracle comparison, metamorphic tests, tools for finding equivalence or faults, or similar techniques. Next, the ML evaluation model determines the performance gains (such as increase in speed, improved cache utilization, higher operations per second, or similar) is attributable to the use of the side-effects. Such measurement may be performed based on code execution or on predictive estimation.

A technical effect of this approach is that it yields performance improvements beyond standard compiler optimizations, by smartly exploiting environment-specific side-effects, whilst also ensuring that code behaviour remains reliable. The at least one candidate code instance generated as a result is leaner, faster, and optimized for its target execution environment, without sacrificing code correctness.

Optionally, the machine learning evaluation model conditions its performance score on runtime data-distribution patterns, thereby favoring the one or more candidate code instances whose heuristics are specialized for the runtime data-distribution patterns. This conditioning allows the ML evaluation model to assess not only the performance characteristic of each candidate code instance but also its projected efficiency under actual data conditions present at runtime. This assessment is made without code execution. The performance characteristic may, for example, comprise one or more of execution time, throughput, branch misprediction rate, cache-hit ratio, memory-access latency, and load-imbalance factor, and may be evaluated in context of the runtime data-distribution patterns. The AI model utilizes the performance score as the feedback, to adjust its parameters or input conditions so that subsequent candidate code instances are biased toward heuristic strategies that are more effective for the prevailing or anticipated runtime data distribution patterns. A technical effect of this embodiment is that the optimisation process converges toward the at least one candidate code instance that is not only high-performing in general but also specialised for real-world input characteristics of the workload. This targeted adaptation improves effective throughput, reduces wasted computation on rare cases, and enhances resource utilisation by aligning heuristic behaviour with the runtime data-distribution patterns.

The term “runtime data-distribution patterns” refers to statistical or structural characteristics of data being processed during execution, which may include, for example, value frequency distributions, clustering of input elements, sparsity patterns in matrices, or similar. These patterns may be detected, inferred from, or predicted using sampled runtime data, instrumentation feedback, lightweight profiling, predictive estimation based on workload metadata, or similar.

The heuristics specialized for the runtime data-distribution patterns may include, for example, branch prediction hints tuned for expected case frequencies, specialised search or sorting algorithms for known key distributions, memory-access patterns optimised for data locality in sparse or dense datasets, load-balancing strategies for skewed parallel workloads, or similar.

Optionally, the AI model proposes warp-level synchronization and work-partitioning strategies for a GPU kernel, and the machine learning evaluation model predicts warp-divergence or occupancy metrics in scoring each strategy. Optionally, in this regard, the one or more candidate code instances generated by the AI model are variants of the GPU kernel which differ in their warp-level synchronization and work-partitioning strategies. The term “warp-level synchronization” refers to a mechanism in GPU programming where all threads within a warp (i.e., a fixed-size group of threads that execute instructions in lockstep) coordinate or wait for each other at specific execution points to ensure correct ordering or data consistency. Furthermore, the term “work-partitioning strategies” refers to techniques used to divide a workload into tasks assigned to individual warps or threads.

The ML evaluation model optionally determines the performance score, without executing said variants of the GPU kernel, by predicting the performance characteristic such as warp-divergence and/or occupancy metrics. The warp-divergence is indicative of execution efficiency while the occupancy metrics are indicative of utilization of GPU's execution resources. The AI model utilizes the performance score as the feedback, to adjust its parameters or input conditions (for example, such as synchronisation granularity, task distribution patterns, warp assignment heuristics, or similar) so that subsequent candidate code instances that are generated are biased toward warp-level strategies with lower predicted warp-divergence and higher predicted occupancy metrics.

A technical effect of the above embodiment is that the iterative optimisation process converges toward the at least one candidate code instance that achieves efficient parallel execution on GPUs by minimising wasted cycles and maximising utilisation of available processing resources. This targeted optimisation improves throughput, reduces execution latency, and enhances scalability for GPU workloads, relative to other candidate code instances generated previously in the iterative process.

Optionally, each candidate code instance re-orders a set of functions or tasks to exploit temporal locality or data dependencies, and the machine learning evaluation model scores the reorderings based on reduced synchronization overhead or cache thrashing. Said re-ordering is implemented, by the AI model, when generating the one or more candidate code instances. Temporal locality enables faster execution when tasks that access the same data are scheduled closely in time, so the data remains available in cache when needed. Data dependencies ensure logical correctness by requiring that a task which depends on the result of another is executed after that task. The ML evaluation model optionally determines the performance score of each candidate code instance, without executing any candidate code instance, by predicting the performance characteristic such as synchronization overhead and/or cache thrashing. A lower predicted synchronisation overhead and/or reduced cache thrashing results in a higher performance score. The AI model utilizes the performance score as the feedback, to adjust its parameters or input conditions so that subsequent candidate code instances that are generated are biased toward reorderings that are more likely to minimise synchronisation overhead and cache thrashing.

A technical effect of the above embodiment is that the iterative optimisation process converges toward the at least one candidate code instance that executes tasks in an order optimised for data reuse and dependency constraints, thereby reducing waiting times, lowering memory traffic, and improving overall execution efficiency relative to other candidate code instances generated earlier in the process.

Optionally, the AI model generates the one or more candidate code instances that selectively weaken memory-coherence guarantees, and the machine learning evaluation model confirms functional correctness under a relaxed model with weakened memory-coherence guarantees while scoring the one or more candidate code instances for latency reductions arising from decreased synchronization. When memory-coherence guarantees are strong, it means that memory stays in sync across different processors or threads. This requires use of synchronization mechanisms involving rules and procedures, which can slow code execution. A synchronization barrier can stop all threads until all data is synchronized across all cores or memory units. Selectively weakening memory-coherence guarantees in the one or more candidate code instances relaxes these rules and procedures wherever it is feasible to do so, in a manner that does not compromise on code accuracy.

The ML evaluation model optionally validates functional correctness, without code execution, to ensure that candidate code instances produce correct results despite the decreased synchronization, and generates the performance score based on the performance characteristic, for example, such as latency. A higher predicted reduction in latency arising from the decreased synchronization results in a higher performance score. The AI model uses this feedback to adjust its parameters or input conditions so that subsequent candidate code instances it generates are biased toward coherence-relaxation strategies that are more likely to achieve higher performance scores.

A technical effect of the above embodiment is that the iterative optimisation process converges toward the at least one candidate code instance that achieves lower execution latency and reduced synchronisation overhead, while preserving functional correctness. This enables more efficient parallel execution and better utilisation of available processing resources in the target execution environment, relative to other candidate code instances generated earlier in the process.

Optionally, the one or more candidate code instances include alternative CUDA-kernel or PTX-level implementations of a computation, and the machine learning evaluation model measures or predicts occupancy, register usage, and achieved memory bandwidth to score each of the CUDA-kernel or PTX-level implementations. The alternative CUDA-kernel or PTX-level implementations are different low-level GPU implementations of the same computation. The ML evaluation model evaluates performance scores for each such implementation, based on the performance characteristic of GPU performance such as one or more of occupancy, register usage, and memory bandwidth. For example, a higher predicted occupancy or a higher predicted memory bandwidth may result in a higher performance score. Said determination by the ML evaluation model may be based on actual code execution or may be a predictive assessment without code execution. This scoring enables identification of the best implementation amongst the generated implementations.

When the AI model uses these performance scores as the feedback, it adjusts its parameters or input conditions (for example, such as kernel launch configuration, memory-access strategies, register allocation heuristics, or similar) so that subsequent candidate code instances are biased toward low-level implementations more likely to achieve higher GPU performance scores.

A technical effect of the above embodiment is that the iterative optimisation process converges toward the at least one candidate code instance whose low-level GPU implementation maximises hardware utilisation, reduces execution latency, and improves throughput relative to other candidate code instances generated earlier in the iterative process. This targeted approach enables performance tuning at the CUDA or PTX level, achieving gains beyond those typically obtained from high-level source-level optimisation alone.

Optionally, the one or more candidate code instances include alternative WebAssembly code sequences implementing identical semantics, and the machine learning evaluation model scores each WebAssembly code sequence for execution latency on a target WebAssembly runtime. The alternative WebAssembly code sequences are generated such that they are different implementations that are semantically equivalent (i.e., they produce exactly the same result when executed). The generation of alternative WebAssembly code sequences by the AI model may involve applying instruction substitutions, reordering independent instructions, loop transformations, memory-access pattern adjustments, or other low-level code modifications that preserve functional correctness while potentially changing execution performance.

The ML evaluation model evaluates the performance score for each candidate code instance, based on the performance characteristic such as the execution latency on the target WebAssembly runtime. This evaluation is performed without code execution. A lower execution latency may result in a higher performance score. The target WebAssembly runtime may be a browser-integrated WebAssembly engine or a standalone WebAssembly virtual machine. The execution latency prediction may take into account runtime-specific optimisation behaviours such as instruction fusion, just-in-time compilation strategies, and memory model handling.

When the AI model uses these performance scores as the feedback, it adjusts its parameters or input conditions (for example, such as biasing toward optimizable instruction sequences) so that subsequent candidate code instances are more likely to yield lower execution latency on the target WebAssembly runtime.

A technical effect of the above embodiment is that the iterative optimisation process converges toward at least one candidate code instance whose WebAssembly implementation is tailored for the specific target WebAssembly runtime environment, thereby achieving reduced execution latency, improved runtime responsiveness, and better alignment with the at least one performance metric, relative to other candidate code instances generated earlier in the process.

Optionally, the one or more candidate code instances include alternative Java-byte-code sequences or invoked dynamic call-site configurations, and the machine learning evaluation model scores each Java-byte-code sequence or invoked dynamic call-site configuration based on predicted JIT compilation quality and runtime performance on a target Java Virtual Machine (JVM). The alternative Java-byte-code sequences are generated such that they are semantically equivalent (i.e., for same inputs they produce same results and observable side effects) but differ in their bytecode structure, instruction selection, or arrangement in a way that may differently influence the JIT compilation quality. The alternative invoked dynamic call-site configurations correspond to different linkages or binding strategies for call sites that are resolved at runtime, and may therefore have different runtime performance. Optionally, the code optimisation context comprise information describing the target JVM's JIT compilation strategies, tiered compilation thresholds, inlining heuristics, or runtime profiling behaviour. As a result, generated alternative sequences or configurations can be tailored according to the target JVM.

The ML evaluation model evaluates the performance score for each candidate code instance, without code execution, based on the performance characteristic comprising the JIT compilation quality and the runtime performance on the target JVM. The JIT compilation quality depends on one or more of JIT compilation time, generated native code size, steady-state execution time, garbage-collection pressure, overall throughput, and/or similar. A higher JIT compilation quality and/or a higher runtime performance may result in a higher performance score.

When the AI model uses these performance scores as the feedback, it adjusts its parameters or input conditions (for example, such as bytecode transformation strategies, call-site binding preferences, or similar) so that subsequent candidate code instances are biased toward alternatives that are more likely to achieve higher performance scores on the target JVM.

A technical effect of the above embodiment is that the iterative optimisation process converges towards at least one candidate code instance whose Java-byte-code structure or call-site configuration is optimised to leverage a JIT compiler's strengths in the target JVM environment, thereby achieving improved runtime performance, reduced compilation overhead, and better alignment with the at least one performance metric, relative to other candidate code instances generated earlier in the process.

Optionally, the AI model generates the one or more candidate code instances that combine low-level machine instructions in novel sequences differing from patterns produced by conventional compilers, and the machine learning evaluation model verifies functional equivalence and scores performance of the one or more candidate code instances based on instruction-throughput metrics. Optionally, in this regard, the AI model generates the one or more candidate code instances by employing at least one of: instruction substitution, instruction re-ordering, instruction fusion, micro-operation packing. Furthermore, optionally, such generation of the one or more candidate code instances is guided by at least one of: reinforcement learning, evolutionary search, constraint solving. Said generation focuses on instruction-level transformations rather than higher-level structures. The “novel sequences” are orderings or arrangements of instructions that are semantically equivalent to a baseline implementation, but deviate from instruction patterns of conventional compiler backends for a same functionality

The ML evaluation model optionally verifies the functional equivalence of each candidate code instance by comparing its expected outputs and side effects with those of a reference implementation. The ML evaluation model then evaluates the performance score for each candidate code instance, without executing the candidate code instance, based on the performance characteristic such as the instruction throughput metrics (which depend on one or more of instructions-per-cycle (IPC), execution port utilisation efficiency, pipeline stall rate, instruction-cache pressure, or similar). Higher instruction throughput metrics (for example, as high IPC, low stall rate, or similar) may result in a higher performance score.

The AI model uses the performance scores as feedback to adjust its parameters or input conditions (for example, by adjusting instruction-substitution rules, re-ordering heuristics, or similar), so that subsequent candidate code instances are biased toward novel instruction sequences with higher throughput.

A technical effect of the above embodiment is that the iterative optimisation process converges toward at least one candidate code instance whose machine-level instruction sequence is novel relative to conventional compiler output yet functionally equivalent, enabling improvements in instruction throughput and execution efficiency. This approach allows performance gains to be achieved by uncovering unconventional instruction combinations that reduce stalls, improve parallel execution, or better utilise processor pipelines, without changing intended code behaviour.

In a second aspect, an embodiment of the present disclosure provides a system for iteratively optimizing executable code solving a programming problem using artificial intelligence (AI), the system comprising:
at least one processor; and
a non-transitory computer-readable memory storing machine-readable instructions that, when executed by the at least one processor, cause the at least one processor to:
(1) receive one or more input data sets describing a code optimization context and at least one performance metric for the programming problem;
(2) generate, using an AI model, one or more candidate code instances as proposed solutions to the programming problem, wherein the generation is conditioned on a structured semantic representation of the code optimization context and on the at least one performance metric;
(3) evaluate, for each candidate code instance, a performance score using a machine learning evaluation model distinct from the AI model, the performance score indicating a performance characteristic of the one or more candidate code instances with respect to the at least one performance metric;
(4) adjust one or more parameters or input conditions of the AI model for a subsequent iteration of candidate code generation based on feedback from the evaluation;
(5) repeat the generating, evaluating, and adjusting operations (2), (3), and (4) iteratively to progressively improve the performance characteristic of the one or more candidate code instances with respect to the at least one performance metric until a termination condition is satisfied; and
(6) select, upon satisfaction of the termination condition, at least one candidate code instance as an optimized executable code solution to the programming problem, and output the selected at least one candidate code instance.

The present disclosure provides the aforementioned system. The system implements the computer-implemented method within an AI-driven hardware-integrated architecture comprising the at least one processor and the non-transitory computer-readable memory. The architecture is inherently scalable and deployable across a range of hardware configurations. By executing the method's optimization process without full code execution during evaluation, the system conserves processor cycles, reduces memory-bandwidth consumption, and lowers power usage, when compared to conventional code optimization solutions. In the system, processing hardware resources are directed toward candidate code instances with high predicted performance, and the feedback loop between the ML evaluation model and the AI model continuously refines code generation parameters or input conditions based on results of prior evaluations, further improving the system's throughput and responsiveness across diverse workloads. Notably, all advantages of the first aspect are inherently applicable to the system too, with the additional benefit that these improvements are realized directly at the hardware level, thereby optimizing performance and efficiency of a physical computing environment.

The present disclosure also relates to the system as described above. Various embodiments and variants disclosed above, with respect to the aforementioned first aspect, apply mutatis mutandis to the system.

In the system, the at least one processor is communicably coupled to the non-transitory computer-readable memory. In some implementations, the at least one processor and the non-transitory computer-readable memory are implemented on a single computing device, whereas in other implementations, the non-transitory computer-readable memory is implemented externally to a computing device which comprises the at least one processor.

Optionally, the at least one processor is implemented as a single processor. Alternatively, optionally, the at least one processor is implemented as a plurality of processors, wherein the AI model and the ML evaluation model are implemented on different processors.

Optionally, in the system, the code optimization context comprises a sequence of machine-level or intermediate-representation instructions, and the iterative generation and evaluation steps optimize ordering of those instructions to minimize pipeline stalls or branch mis-predictions while preserving functional equivalence of the one or more candidate code instances.

Optionally, in the system, the one or more candidate code instances encode alternative memory-layout configurations for data structures, and the machine learning evaluation model computes performance scores that reflect reductions in cache-miss rates, avoidance of memory-bank conflicts, or improved locality across multiple cache levels.

Optionally, in the system, each candidate code instance specifies a unit of parallelism for executing a workload, and the machine learning evaluation model predicts execution-time or throughput improvements arising from a granularity indicated by the unit of parallelism.

Optionally, in the system, the iterative generation produces candidate sets of function-inlining directives, and the machine learning evaluation model scores each candidate set according to a weighted objective that balances call-overhead reduction against instruction-cache pressure.

Optionally, in the system, each candidate code instance represents a just-in-time compilation strategy and the machine learning evaluation model selects a strategy that is projected to yield a highest runtime performance for current workload characteristics.

Optionally, in the system, the at least one processor is configured to generate multiple semantically equivalent variants of a function or a kernel, executing each variant to verify semantic equivalence, and evaluating the variants for performance or resource-utilization improvements before selecting at least one variant as an optimized implementation.

Optionally, in the system, the AI model generates the one or more candidate code instances that leverage documented or undocumented side-effects of target execution environments to reduce instruction count, and the machine learning evaluation model validates functional correctness of the one or more candidate code instances while measuring performance gains attributable to the side-effects.

Optionally, in the system, the machine learning evaluation model conditions its performance score on runtime data-distribution patterns, thereby favoring the one or more candidate code instances whose heuristics are specialized for the runtime data-distribution patterns.

Optionally, in the system, the AI model proposes warp-level synchronization and work-partitioning strategies for a GPU kernel, and the machine learning evaluation model predicts warp-divergence or occupancy metrics in scoring each strategy.

Optionally, in the system, each candidate code instance re-orders a set of functions or tasks to exploit temporal locality or data dependencies, and the machine learning evaluation model scores the reorderings based on reduced synchronization overhead or cache thrashing.

Optionally, in the system, the AI model generates the one or more candidate code instances that selectively weaken memory-coherence guarantees, and the machine learning evaluation model confirms functional correctness under a relaxed model with weakened memory-coherence guarantees while scoring the one or more candidate code instances for latency reductions arising from decreased synchronization.

Optionally, in the system, the one or more candidate code instances include alternative CUDA-kernel or PTX-level implementations of a computation, and the machine learning evaluation model measures or predicts occupancy, register usage, and achieved memory bandwidth to score each of the CUDA-kernel or PTX-level implementations.

Optionally, in the system, the one or more candidate code instances include alternative WebAssembly code sequences implementing identical semantics, and the machine learning evaluation model scores each WebAssembly code sequence for execution latency on a target WebAssembly runtime.

Optionally, in the system, the one or more candidate code instances include alternative Java-byte-code sequences or invoked dynamic call-site configurations, and the machine learning evaluation model scores each Java-byte-code sequence or invoked dynamic call-site configuration based on predicted JIT compilation quality and runtime performance on a target Java Virtual Machine (JVM).

Optionally, in the system, the AI model generates the one or more candidate code instances that combine low-level machine instructions in novel sequences differing from patterns produced by conventional compilers, and the machine learning evaluation model verifies functional equivalence and scores performance of the one or more candidate code instances based on instruction-throughput metrics.

Optionally, in some embodiments, the evaluation may include execution of one or more candidate code instances in addition to, or as an alternative to, predictive estimation. For example, execution may be performed to verify semantic equivalence, to obtain empirical performance measurements, or to confirm correctness under specific runtime conditions. Accordingly, the evaluation may be performed by predictive-only techniques, execution-only techniques, or any combination of predictive and execution-based techniques. A technical effect of this flexibility is that the optimization process achieves both efficiency and robustness, since predictive evaluation enables rapid exploration of large design spaces while optional execution provides empirical validation and increased reliability of the optimized executable code solutions.

### DETAILED DESCRIPTION OF THE DRAWINGS

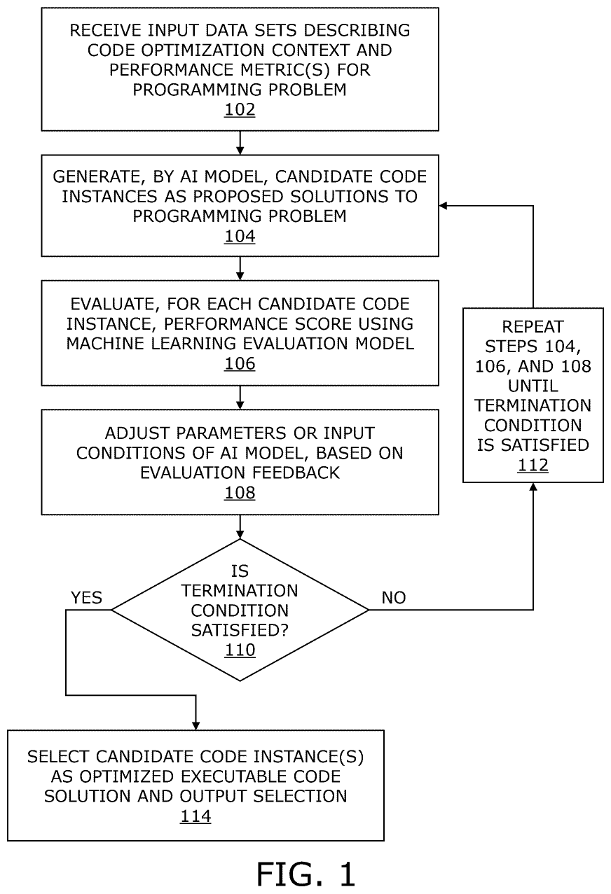

Referring to FIG. 1, illustrated is a flowchart illustrating steps of a computer-implemented method for iteratively optimizing executable code solving a programming problem using artificial intelligence (AI), in accordance with an embodiment of the present disclosure. The method comprises executing machine-readable instructions stored on a non-transitory computer-readable memory by at least one processor for steps described hereinbelow.

At step 102, one or more input data sets describing a code optimization context and at least one performance metric for the programming problem, are received. At step 104, one or more candidate code instances are generated, as proposed solutions to the programming problem, by an AI model. The generation is conditioned on a structured semantic representation of the code optimization context and on the at least one performance metric. At step 106, for each candidate code instance, a performance score is evaluated using a machine learning evaluation model distinct from the AI model, the performance score indicating a performance characteristic of the one or more candidate code instances with respect to the at least one performance metric. At step 108, one or more parameters or input conditions of the AI model are adjusted for a subsequent iteration of candidate code generation, based on feedback from the evaluation. At step 110, it is checked whether a termination condition is satisfied. At step 112, the steps 104, 106, and 108 are repeated iteratively to progressively improve the performance characteristic of the one or more candidate code instances with respect to the performance metric until the termination condition is satisfied at the step 110. At step 114, upon satisfaction of the termination condition at the step 110, at least one candidate code instance is selected as an optimized executable code solution to the programming problem, and outputting the selected at least one candidate code instance.

The aforementioned steps are only illustrative and other alternatives can also be provided where one or more steps are added, one or more steps are removed, or one or more steps are provided in a different sequence without departing from the scope of the claims.

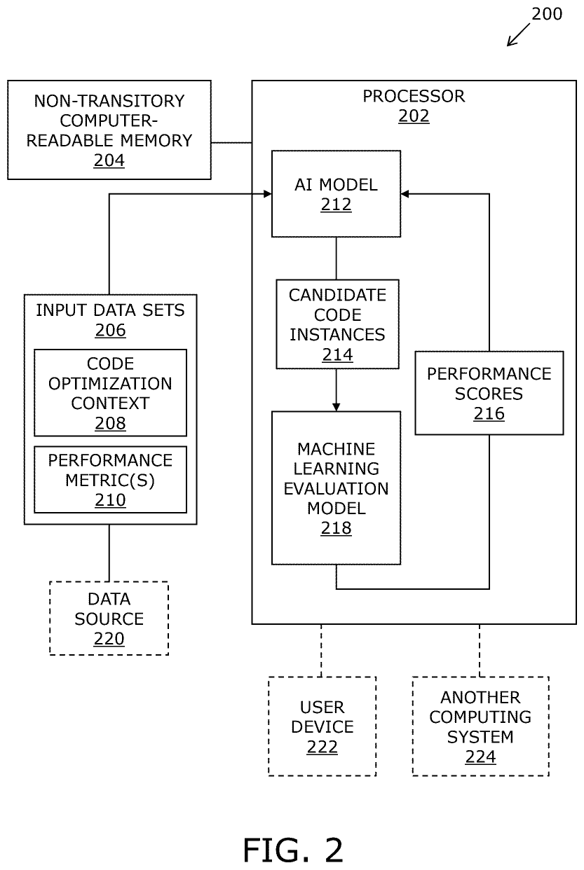

Referring to FIG. 2, illustrated is a block diagram of a system 200 for iteratively optimizing executable code solving a programming problem using artificial intelligence (AI), in accordance with an embodiment of the present disclosure. The system 200 comprises at least one processor (depicted as a processor 202), and a non-transitory computer-readable memory 204 storing machine-readable instructions that, when executed by the processor 202, cause the processor 202 to:
(1) receive one or more input data sets 206 describing a code optimization context 208 and at least one performance metric 210 for the programming problem;
(2) generate, using an AI model 212, one or more candidate code instances 214 as proposed solutions to the programming problem, wherein the generation is conditioned on a structured semantic representation of the code optimization context 208 and on the at least one performance metric 210;
(3) evaluate, for each candidate code instance, a performance score 216 using a machine learning evaluation model 218 distinct from the AI model 212, the performance score indicating a performance characteristic of the one or more candidate code instances 214 with respect to the at least one performance metric 210;
(4) adjust one or more parameters or input conditions of the AI model 212 for a subsequent iteration of candidate code generation based on feedback from the evaluation;
(5) repeat the generating, evaluating, and adjusting operations (2), (3), and (4) iteratively to progressively improve the performance characteristic of the one or more candidate code instances 214 with respect to the at least one performance metric 210 until a termination condition is satisfied; and
(6) select, upon satisfaction of the termination condition, at least one candidate code instance as an optimized executable code solution to the programming problem, and output the selected at least one candidate code instance.

Optionally, the one or more input data sets 206 may be received from at least one data source (depicted as a data source 220). Optionally, the selected at least one candidate code instance may be outputted by one or more of: displaying on a user interface of a user device 222, storing in the non-transitory computer-readable memory 204, transmitting to another computing system 224 over a communication interface, integrating into a downstream software build or deployment pipeline, or similar.

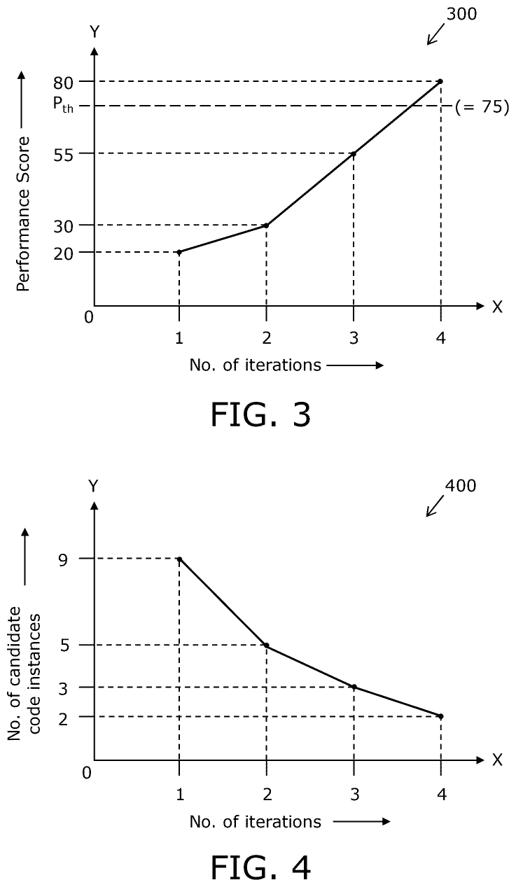

Referring to FIG. 3, illustrated is an exemplary graphical representation 300 illustrating iterative optimization of executable code, in accordance with an embodiment of the present disclosure. In the graphical representation 300, X-axis represents number of iterations, and Y-axis represents a performance score of one or more candidate code instances generated and evaluated at each iteration. For example, the Y-axis may represent a highest performance score from amongst performance scores of the one or more candidate code instances generated and evaluated at each iteration. The one or more candidate code instances are executable code that is to be optimized.

Let us consider, for example, that a termination condition (for the iterative optimization) is that a performance score of at least candidate code instance is greater than a target performance threshold Pₜₕ for at least one performance metric. In this exemplary graphical representation 300, we may consider Pₜₕ=75, as shown. The exemplary graphical representation 300 shows, for example, that the highest performance score increases with an increase in the number of iterations, and at a 4th iteration, the highest performance score is greater than the target performance threshold Pₜₕ. Therefore, at least one candidate code instance from amongst the one or more candidate code instances that are generated and evaluated at the 4th iteration, may be selected as an optimized executable code solution to a programming problem. In other words, the optimized executable code may be the selected at least one candidate code instance.

FIG. 4 is an exemplary graphical representation 400 illustrating convergence towards an optimized executable code solution to a programming problem, by iterative optimization of executable code, in accordance with an embodiment of the present disclosure. In the graphical representation 400, X-axis represents number of iterations, and Y-axis represents a number of candidate code instances that are generated and evaluated at each iteration. The candidate code instances are executable code that is to be optimized.

The exemplary graphical representation 400 shows, for example, that the number of candidate code instances that are generated and evaluated at each iteration decreases with an increase in the number of iterations. Let us consider, for example, that a termination condition is satisfied at a 4th iteration. In this case, at least one candidate code instance from amongst 2 candidate code instances may be selected as an optimized executable code solution to a programming problem. In other words, the optimized executable code may be the selected at least one candidate code instance.

Provided figures are merely examples, which should not unduly limit the scope of the claims herein. A person skilled in the art will recognize many variations, alternatives, and modifications of embodiments of the present disclosure.

What is claimed is:

1. A computer-implemented method for iteratively optimizing executable code solving a programming problem using artificial intelligence (AI), the method comprising executing machine-readable instructions stored on a non-transitory computer-readable memory by at least one processor for:
(i) receiving one or more input data sets describing a code optimization context and at least one performance metric for the programming problem;
(ii) generating, by an AI model, one or more candidate code instances as proposed solutions to the programming problem, wherein the generation is conditioned on a structured semantic representation of the code optimization context and on the at least one performance metric;
(iii) evaluating, for each candidate code instance, a performance score using a machine learning evaluation model distinct from the AI model, the performance score indicating a performance characteristic of the one or more candidate code instances with respect to the at least one performance metric;
(iv) adjusting one or more parameters or input conditions of the AI model for a subsequent iteration of candidate code generation, based on feedback from the evaluation;
(v) repeating steps (ii), (iii), and (iv) iteratively to progressively improve the performance characteristic of the one or more candidate code instances with respect to the performance metric until a termination condition is satisfied; and
(vi) selecting, upon satisfaction of a termination condition, at least one candidate code instance as an optimized executable code solution to the programming problem, and outputting the selected at least one candidate code instance.

2. The method of claim 1, wherein the code optimization context comprises a sequence of machine-level or intermediate-representation instructions, and the iterative generation and evaluation steps optimize ordering of those instructions to minimize pipeline stalls or branch mis-predictions while preserving functional equivalence of the one or more candidate code instances.

3. The method of claim 1, wherein the one or more candidate code instances encode alternative memory-layout configurations for data structures, and the machine learning evaluation model computes performance scores that reflect reductions in cache-miss rates, avoidance of memory-bank conflicts, or improved locality across multiple cache levels.

4. The method of claim 1, wherein each candidate code instance specifies a unit of parallelism for executing a workload, and the machine learning evaluation model predicts execution-time or throughput improvements arising from a granularity indicated by the unit of parallelism.

5. The method of claim 1, wherein the iterative generation produces candidate sets of function-inlining directives, and the machine learning evaluation model scores each candidate set according to a weighted objective that balances call-overhead reduction against instruction-cache pressure.

6. The method of claim 1, wherein each candidate code instance represents a just-in-time compilation strategy and the machine learning evaluation model selects a strategy that is projected to yield a highest runtime performance for current workload characteristics.

7. The method of claim 1, further comprising generating multiple semantically equivalent variants of a function or a kernel, executing each variant to verify semantic equivalence, and evaluating the variants for performance or resource-utilization improvements before selecting at least one variant as an optimized implementation.

8. The method of claim 1, wherein the AI model generates the one or more candidate code instances that leverage documented or undocumented side-effects of target execution environments to reduce instruction count, and the machine learning evaluation model validates functional correctness of the one or more candidate code instances while measuring performance gains attributable to the side-effects.

9. The method of claim 1, wherein the machine learning evaluation model conditions its performance score on runtime data-distribution patterns, thereby favoring the one or more candidate code instances whose heuristics are specialized for the runtime data-distribution patterns.

10. The method of claim 1, wherein the AI model proposes warp-level synchronization and work-partitioning strategies for a GPU kernel, and the machine learning evaluation model predicts warp-divergence or occupancy metrics in scoring each strategy.

11. The method of claim 1, wherein each candidate code instance re-orders a set of functions or tasks to exploit temporal locality or data dependencies, and the machine learning evaluation model scores the reorderings based on reduced synchronization overhead or cache thrashing.

12. The method of claim 1, wherein the AI model generates the one or more candidate code instances that selectively weaken memory-coherence guarantees, and the machine learning evaluation model confirms functional correctness under a relaxed model with weakened memory-coherence guarantees while scoring the one or more candidate code instances for latency reductions arising from decreased synchronization.

13. The method of claim 1, wherein the one or more candidate code instances include alternative CUDA-kernel or PTX-level implementations of a computation, and the machine learning evaluation model measures or predicts occupancy, register usage, and achieved memory bandwidth to score each of the CUDA-kernel or PTX-level implementations.

14. The method of claim 1, wherein the one or more candidate code instances include alternative WebAssembly code sequences implementing identical semantics, and the machine learning evaluation model scores each WebAssembly code sequence for execution latency on a target WebAssembly runtime.

15. The method of claim 1, wherein the one or more candidate code instances include alternative Java-byte-code sequences or invoked dynamic call-site configurations, and the machine learning evaluation model scores each Java-byte-code sequence or invoked dynamic call-site configuration based on predicted JIT compilation quality and runtime performance on a target Java Virtual Machine (JVM).

16. The method of claim 1, wherein the AI model generates the one or more candidate code instances that combine low-level machine instructions in novel sequences differing from patterns produced by conventional compilers, and the machine learning evaluation model verifies functional equivalence and scores performance of the one or more candidate code instances based on instruction-throughput metrics.

17. A system for iteratively optimizing executable code solving a programming problem using artificial intelligence (AI), the system comprising:
at least one processor; and
a non-transitory computer-readable memory storing machine-readable instructions that, when executed by the at least one processor, cause the at least one processor to:
(1) receive one or more input data sets describing a code optimization context and at least one performance metric for the programming problem;
(2) generate, using an AI model, one or more candidate code instances as proposed solutions to the programming problem, wherein the generation is conditioned on a structured semantic representation of the code optimization context and on the at least one performance metric;
(3) evaluate, for each candidate code instance, a performance score using a machine learning evaluation model distinct from the AI model, the performance score indicating a performance characteristic of the one or more candidate code instances with respect to the at least one performance metric;
(4) adjust one or more parameters or input conditions of the AI model for a subsequent iteration of candidate code generation based on feedback from the evaluation;
(5) repeat the generating, evaluating, and adjusting operations (2), (3), and (4) iteratively to progressively improve the performance characteristic of the one or more candidate code instances with respect to the at least one performance metric until a termination condition is satisfied; and
(6) select, upon satisfaction of the termination condition, at least one candidate code instance as an optimized executable code solution to the programming problem, and output the selected at least one candidate code instance.
